(19) United States
(12) Patent Application Publication
(10) Pub. No.: US 2025/0196718 A1
(43) Pub. Date: Jun. 19, 2025

(54) TEMPERATURE CONTROL SYSTEM

(71) Applicant: Honda Motor Co., Ltd., Tokyo (JP)

(72) Inventors: Yasushi OGIHARA, Saitama (JP); Daichi Watanabe, Saitama (JP); Yasuo Yamada, Saitama (JP); Takahiro Yasue, Saitama (JP)

(73) Assignee: Honda Motor Co., Ltd., Tokyo (JP)

(21) Appl. No.: 18/923,709

(22) Filed: Oct. 23, 2024

(30) Foreign Application Priority Data
Dec. 15, 2023 (JP) 2023-211794

(51) Int. Cl. B60L 58/26; B60L 58/12

(52) U.S. Cl. CPC B60L 58/26; B60L 58/12; B60L 2240/36

(57) ABSTRACT

A system on a vehicle includes: a first refrigerant circuit provided with a first heat exchanger and configured to allow a refrigerant to flow therethrough to adjust a temperature of a heat generating device of the vehicle; a second refrigerant circuit provided with a second heat exchanger and configured to allow the refrigerant to flow therethrough to adjust a temperature of a power storage device of the vehicle; a valve mechanism provided between the first refrigerant circuit and the second refrigerant circuit; and a control device configured to control the valve mechanism. The first refrigerant circuit includes a flow path configured to allow the refrigerant to flow therethrough while bypassing the first heat exchanger, and a flow path configured to allow the refrigerant to flow through the first heat exchanger, and the control device selects, based on a state of the vehicle, any one of first to fourth modes.

### CROSS-REFERENCE TO RELATED APPLICATIONS

This application is based on and claims priority under 35 USC 119 from Japanese Patent Application No. 2023-211794 filed on Dec. 15, 2023, the contents of which are incorporated herein by reference.

### TECHNICAL FIELD

The present disclosure relates to a temperature control system to be mounted on a vehicle.

### BACKGROUND

In recent years, researches and developments have been conducted on fuel efficiency improvement which contributes to improvement in energy efficiency in order to allow more people to have access to affordable, reliable, sustainable and advanced energy.

United States Patent Publication No. 11390135 (hereinafter, referred to as Patent Literature 1) discloses a thermal management system for a vehicle that achieves both cooling of a high voltage battery and heating in the vehicle while minimizing waste of energy.

In the thermal management system of Patent Literature 1, a cooling circuit through which a refrigerant for cooling a battery flows and a cooling circuit through which a refrigerant for cooling electric components such as a motor and an inverter flows are separately provided, and the refrigerant flowing through these circuits can exchange heat with each other in a heat exchanger.

While it is necessary to appropriately control a temperature of the battery so as not to limit input and output of the battery, a cruising distance of the vehicle is reduced when an amount of power consumption required for controlling the temperature of the battery is large. There is room for improvement in terms of achieving both a temperature control performance of the battery and the cruising distance of the vehicle.

The present disclosure relates to a temperature control system capable of preventing a decrease in a temperature control performance of a power storage device and a cruising distance of a vehicle. This further contributes to the improvement in energy efficiency.

### SUMMARY

An aspect of the present disclosure relates to a temperature control system to be mounted on a vehicle including: a first refrigerant circuit provided with a first heat exchanger and configured to allow a refrigerant to flow therethrough to adjust a temperature of a heat generating device of the vehicle; a second refrigerant circuit provided with a second heat exchanger and configured to allow the refrigerant to flow therethrough to adjust a temperature of a power storage device of the vehicle; a valve mechanism provided between the first refrigerant circuit and the second refrigerant circuit; and a control device configured to control the valve mechanism. The first refrigerant circuit includes a flow path configured to allow the refrigerant to flow therethrough while bypassing the first heat exchanger, and a flow path configured to allow the refrigerant to flow through the first heat exchanger, and the control device selects, based on a state of the vehicle, any one of a first mode in which the first refrigerant circuit and the second refrigerant circuit are not in communication with each other, and the refrigerant does not flow through the first heat exchanger in the first refrigerant circuit, a second mode in which the first refrigerant circuit and the second refrigerant circuit are not in communication with each other, and the refrigerant flows through the first heat exchanger in the first refrigerant circuit, a third mode in which the first refrigerant circuit and the second refrigerant circuit are in communication with each other via the valve mechanism, and the refrigerant does not flow through the first heat exchanger in the first refrigerant circuit, and a fourth mode in which the first refrigerant circuit and the second refrigerant circuit are in communication with each other via the valve mechanism, and the refrigerant flows through the first heat exchanger in the first refrigerant circuit.

According to the present disclosure, a decrease in the temperature control performance of the power storage device and the cruising distance of the vehicle can be prevented.

### BRIEF DESCRIPTION OF DRAWINGS

Exemplary embodiments of the present disclosure will be described in detail based on the following figures, wherein:

FIG. 1 is a schematic diagram showing a vehicle on which a temperature control system of the present disclosure is mounted;

FIG. 2 is a refrigerant circuit diagram of the temperature control system;

FIG. 3 is a block diagram showing a control system of the temperature control system;

FIG. 4 is a refrigerant circuit diagram when the temperature control system is in a first mode;

FIG. 5 is a refrigerant circuit diagram when the temperature control system is in a second mode;

FIG. 6 is a refrigerant circuit diagram when the temperature control system is in a third mode;

FIG. 7 is a refrigerant circuit diagram when the temperature control system is in a fourth mode;

FIG. 8 is a flowchart showing an example of a mode selection process performed by a control device;

FIG. 9 is a table showing conditions for the control device to determine whether to perform cooling via a radiator or via a chiller when the vehicle is traveling;

FIG. 10 is a table showing that the cooling is performed via the radiator when the vehicle is being normally charged; and

FIG. 11 is a table showing conditions for the control device to determine whether to perform cooling via a radiator or via a chiller when the vehicle is being quickly charged.

### DESCRIPTION OF EMBODIMENTS

Hereinafter, a temperature control system according to an embodiment of the present disclosure will be described with reference to the accompanying drawings.

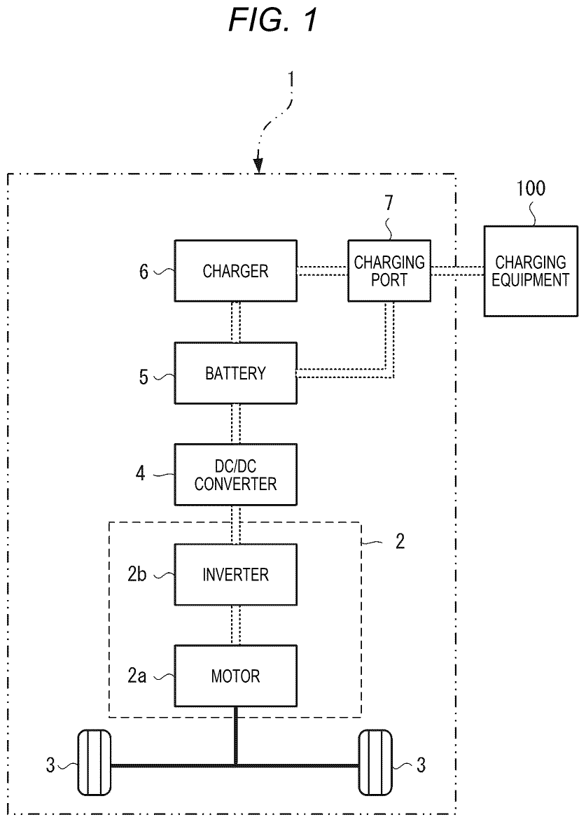

FIG. 1 is a diagram showing a configuration of a vehicle 1 on which a temperature control system according to an embodiment of the present disclosure is mounted. The vehicle 1 is an electric vehicle that can be charged from an external power supply, such as an electric automobile or a plug-in hybrid vehicle, and includes a drive device 2, drive wheels 3, a DC/DC converter 4, a battery 5, and a charger 6.

The drive device 2 includes, for example, a three-phase AC motor 2a and an inverter 2b, and is driven by electric power from the battery 5 to transmit an output of the motor 2a to the drive wheels 3. Further, the motor 2a generates electric power using kinetic energy of the vehicle 1 during deceleration of the vehicle 1. The inverter 2b converts a direct current supplied from the DC/DC converter 4 into an alternating current, outputs the alternating current to the motor 2a, converts an alternating current generated by the motor 2a into a direct current and outputs the direct current to the DC/DC converter 4.

The DC/DC converter 4 steps up electric power supplied from the battery 5, outputs the stepped up electric power to the inverter 2b, steps down the electric power supplied from the inverter 2b and outputs the stepped down electric power to the battery 5.

The battery 5 is a rechargeable secondary battery. Further, the battery 5 supplies electric power to at least one of a drive system, an air conditioning system, and an electrical system of the vehicle 1, and is charged with electric power introduced from a charging equipment 100 (external power supply) installed outside the vehicle 1. The charging equipment 100 is classified into a high-output quick charger using a DC power supply and a normal charger using an AC power supply and having an output lower than that of the quick charger, and the battery 5 can be charged by either a quick charger or a normal charger. The battery 5 mainly supplies electric power to the motor 2a. Further, the battery 5 also supplies electric power to an electric compressor in a refrigeration cycle to be described later, an electric fan 28f of a radiator 28, and the like.

The battery 5 is preferably an all-solid-state battery having resistance to high temperature. The all-solid-state battery is configured by filling a solid electrolyte between a positive electrode and a negative electrode, and is charged and discharged by, for example, transferring lithium ions between the positive electrode and the negative electrode. The solid electrolyte is not particularly limited as long as having lithium ion conductivity and an insulating property, and materials generally used for all-solid-state lithium ion batteries can be used. The all-solid-state battery has a wider management temperature than a liquid battery, and particularly has a higher upper limit temperature than the liquid battery. Therefore, a cooling start temperature of the battery 5 can be set to be higher than a general outside air temperature (for example, 25° C.), and can be set to, for example, 40° C. to 60° C.

The charger 6 converts a current introduced from the charging equipment 100 via a charging port 7, for example, an alternating current into a direct current during normal charging. The charger 6 outputs the converted direct current to the battery 5.

The drive device 2, the DC/DC converter 4, and the charger 6 are heat generating devices that generate heat during operation, and are appropriately cooled by a refrigerant (for example, water or coolant liquid) flowing through a refrigerant circuit. Hereinafter, the drive device 2, the DC/DC converter 4, and the charger 6 are collectively referred to as a heat generating device H. Further, the battery 5 also generates heat during charging or discharging, and is appropriately cooled by the refrigerant flowing through the refrigerant circuit.

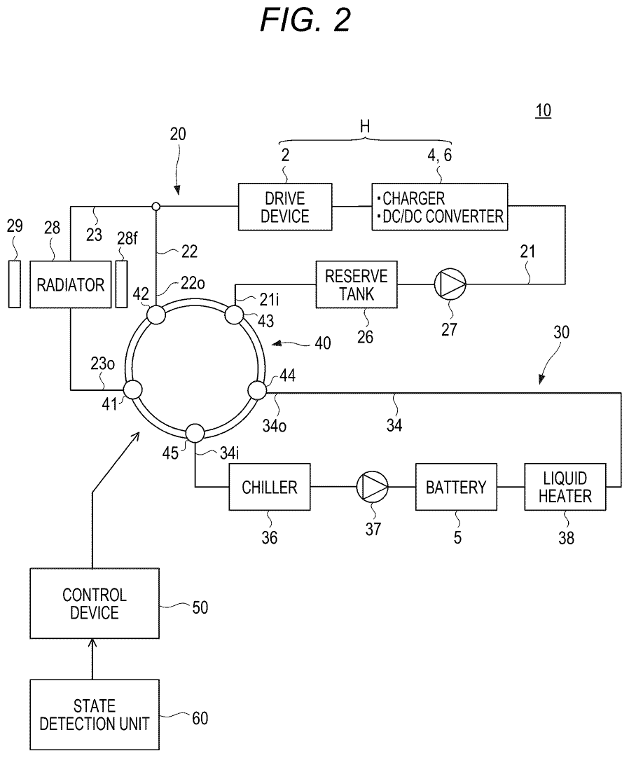

FIG. 2 is a refrigerant circuit diagram of a temperature control system 10 according to the embodiment of the present disclosure. The temperature control system 10 includes a drive device temperature control circuit 20 through which a refrigerant flows to adjust a temperature of the heat generating device H such as the drive device 2, a battery temperature control circuit 30 through which the refrigerant flows to adjust a temperature of the battery 5 (hereinafter also referred to as a battery temperature), a valve mechanism 40 provided between the drive device temperature control circuit 20 and the battery temperature control circuit 30, a control device 50 that manages the temperatures of the battery 5 and the heat generating device H, and a state detection unit 60 that detects a state of the vehicle 1, an outside air temperature, and the like.

The drive device temperature control circuit 20 includes a reserve tank 26 in which the refrigerant is stored, an electric pump 27 that circulates the refrigerant, the charger 6, the DC/DC converter 4, the drive device 2, and the radiator 28. The charger 6, the DC/DC converter 4, and the drive device 2, which are the heat generating device H, are disposed downstream of the electric pump 27. The radiator 28 is provided behind a front grille (not shown) of the vehicle 1, and allows heat exchange between the refrigerant and the outside air. The radiator 28 is disposed downstream of the heat generating device H. Further, the electric fan 28f is provided behind the radiator 28 to promote heat radiation of the refrigerant flowing through the radiator 28. Further, the front grille is provided with an active grille shutter 29, and is configured to be opened and closed in response to an instruction from the control device 50.

The drive device temperature control circuit 20 includes a first flow path 21, a second flow path 22, and a third flow path 23. An inflow port 21i of the first flow path 21 is in communication with the valve mechanism 40, and the reserve tank 26, the electric pump 27, and the heat generating device H are disposed in the first flow path 21. An inflow port of the second flow path 22 is in communication with the first flow path 21, an outflow port 22ₒ is in communication with the valve mechanism 40, and the refrigerant flows while bypassing the radiator 28. An inflow port of the third flow path 23 is in communication with the first flow path 21, an outflow port 23o is in communication with the valve mechanism 40, and the refrigerant flows through the radiator 28. The first flow path 21, the second flow path 22, and the third flow path 23 are connected to the valve mechanism 40 at different positions.

In the battery temperature control circuit 30, a chiller 36, an electric pump 37 that circulates the refrigerant, the battery 5, and a liquid heater 38 capable of warming the refrigerant are arranged in this order. That is, the chiller 36 is disposed upstream of the battery 5, and the liquid heater 38 is disposed downstream of the battery 5.

The chiller 36 is configured to allow heat exchange between the refrigerant flowing through the battery temperature control circuit 30 and an air conditioner refrigerant flowing through a refrigeration cycle (not shown) of HVAC (heating, ventilation, and air conditioning). When the refrigerant flowing through the battery temperature control circuit 30 is cooled via the chiller 36, the electric compressor in the refrigeration cycle is operated to cause a low-temperature air conditioner refrigerant to flow through the chiller 36 even if heating, cooling, or the like is not performed.

The battery temperature control circuit 30 has a fourth flow path 34 in which an inflow port 34i and an outflow port 340 are in communication with the valve mechanism 40, and the refrigerant flows to the battery 5 through the chiller 36. The chiller 36, the electric pump 37, the battery 5, and the liquid heater 38 are arranged in series in the fourth flow path 34. The inflow port 34i and the outflow port 34o of the fourth flow path 34 are connected to the valve mechanism 40 at different positions.

The valve mechanism 40 has five ports 41 to 45. The port 41 is connected to the outflow port 23o of the third flow path 23. The port 42 is connected to the outflow port 22o of the second flow path 22. The port 43 is connected to the inflow port 21i of the first flow path 21. The port 44 is connected to the outflow port 34o of the fourth flow path 34. The port 45 is connected to the inflow port 34i of the fourth flow path 34. The ports 41 to 45 are configured to selectively communicate with each other via, for example, an internal passage provided in the valve mechanism 40.

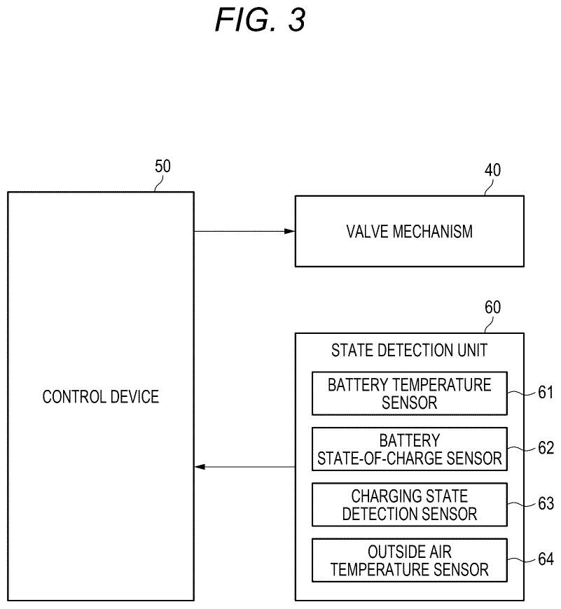

FIG. 3 is a block diagram showing a control system of the temperature control system 10. The control device 50 controls the valve mechanism 40 to change a flow of the refrigerant flowing through the drive device temperature control circuit 20, the battery temperature control circuit 30, and the valve mechanism 40, thereby managing the temperatures of the battery 5 and the heat generating device H. Further, the control device 50 also performs on/off control of the liquid heater 38, the electric compressor in the refrigeration cycle, and the like. The control device 50 is implemented by an electronic control unit (ECU) including a processor, a memory, an interface, and the like.

The control device 50 controls the valve mechanism 40 based on the state of the vehicle 1 and the outside air temperature detected by the state detection unit 60.

The state detection unit 60 includes a battery temperature sensor 61 that detects the battery temperature, a battery state-of-charge sensor 62 that detects a state of charge (SOC) of the battery 5, a charging state detection sensor 63 that detects whether the vehicle 1 is connected to the charging equipment 100 and is in a charging state, and an outside air temperature sensor 64. The battery state-of-charge sensor 62 includes, for example, a current sensor and a voltage sensor for the battery 5. The charging state detection sensor 63 detects, for example, whether a connector of the charging equipment 100 is connected to the charging port 7. Further, when it is detected that the vehicle 1 is being charged, the charging state detection sensor 63 further detects whether the vehicle 1 is being normally charged or being quickly charged. The state detection unit 60 transmits the obtained detection value to the control device 50.

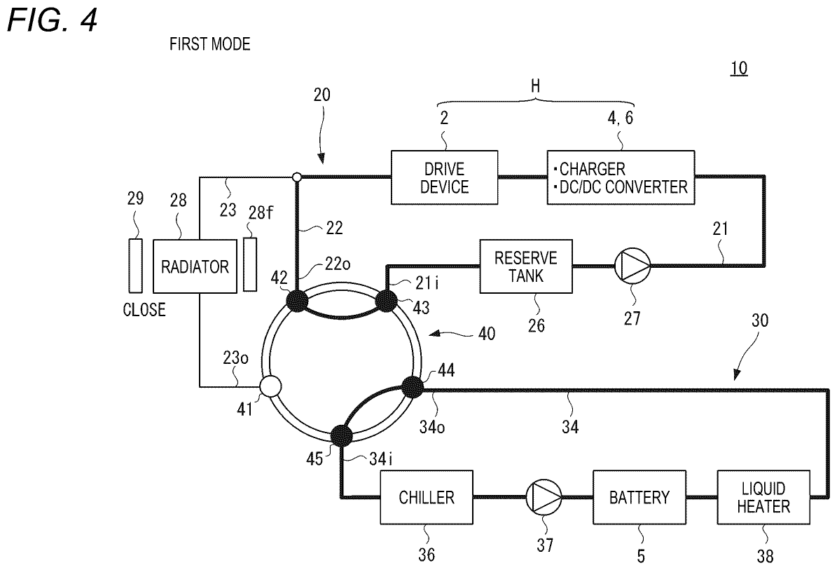

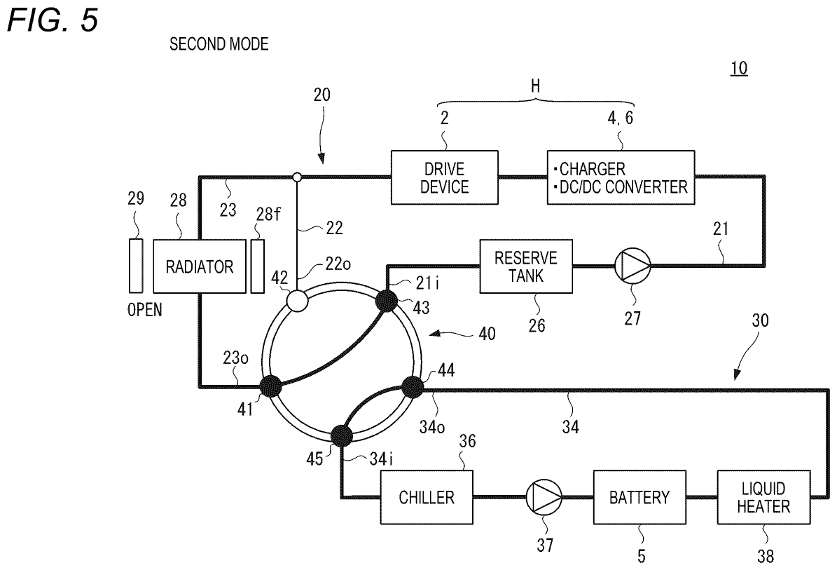

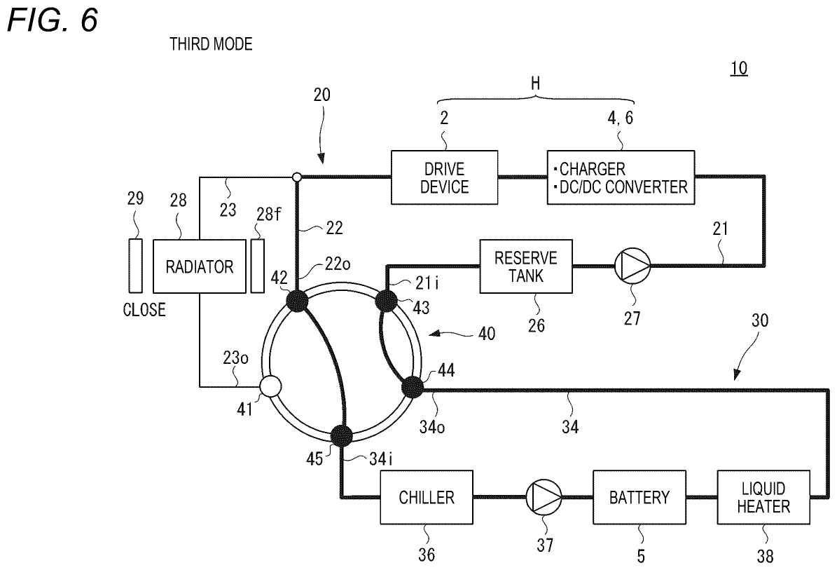

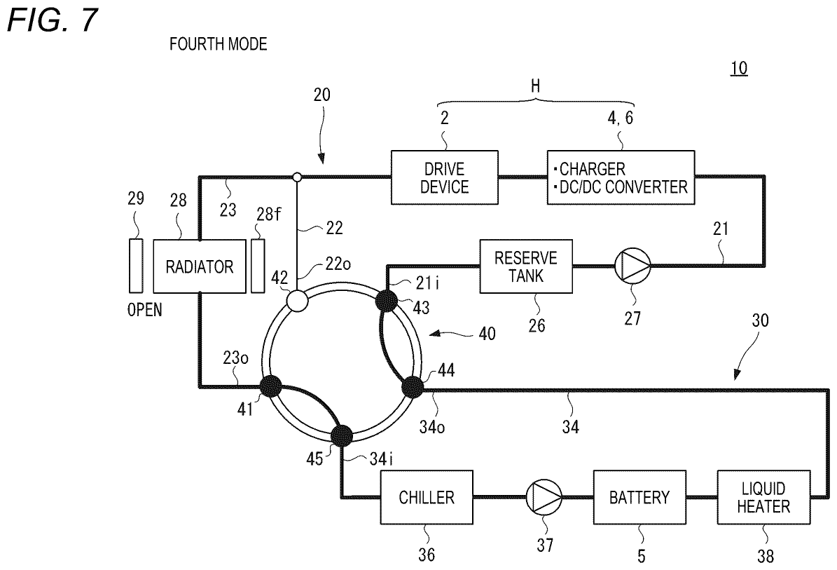

As shown in FIGS. 4 to 7, the valve mechanism 40 is configured to be switched between a communication state (FIGS. 6 and 7) in which the drive device temperature control circuit 20 and the battery temperature control circuit 30 are in communication with each other and a non-communication state (FIGS. 4 and 5) in which the drive device temperature control circuit 20 and the battery temperature control circuit 30 are not in communication with each other. Thick solid lines shown in FIGS. 4 to 7 indicate the flow of the refrigerant. As described above, the battery 5, which is an all-solid-state battery, has resistance to high temperature, and the management temperature is substantially the same as that of the heat generating device H. Thus, even when the drive device temperature control circuit 20 and the battery temperature control circuit 30 are in the communication state, the temperatures of the battery 5 and the heat generating device H can be managed.

Further, the valve mechanism 40 is configured to be switched between a state in which the refrigerant flows through the second flow path 22 of the drive device temperature control circuit 20 and does not flow through the radiator 28 and a state in which the refrigerant flows through the third flow path 23 of the drive device temperature control circuit 20 and flows through the radiator 28.

By such switching, the temperature control system 10 has four modes (a first mode to a fourth mode) regarding the flow of the refrigerant flowing through the drive device temperature control circuit 20, the battery temperature control circuit 30, and the valve mechanism 40, and the control device 50 selects any one of the modes based on the state of the vehicle 1.

As shown in FIG. 4, the first mode is a mode in which the drive device temperature control circuit 20 and the battery temperature control circuit 30 are not in communication with each other (that is, the non-communication state), and the refrigerant does not flow through the radiator 28 in the drive device temperature control circuit 20. The port 42 and the port 43 are in communication with each other via the internal passage of the valve mechanism 40, and thus the first flow path 21 and the second flow path 22 form a closed circuit via the valve mechanism 40 in the drive device temperature control circuit 20. Further, the port 44 and the port 45 are in communication with each other via the internal passage of the valve mechanism 40, and thus the fourth flow path 34 forms a closed circuit via the valve mechanism 40 in the battery temperature control circuit 30. That is, in the first mode, the drive device temperature control circuit 20 and the battery temperature control circuit 30 are independent of each other.

In the first mode, heat is not radiated from the radiator 28, and the refrigerant circulating through the drive device temperature control circuit 20 stores heat received from the heat generating device H. Meanwhile, the refrigerant circulating through the battery temperature control circuit 30 warms the battery 5 by operating the liquid heater 38 or cools the battery 5 via the chiller 36.

As shown in FIG. 5, the second mode is a mode in which the drive device temperature control circuit 20 and the battery temperature control circuit 30 are not in communication with each other (that is, the non-communication state), and the refrigerant flows through the radiator 28 in the drive device temperature control circuit 20. The port 41 and the port 43 are in communication with each other via the internal passage of the valve mechanism 40, and thus the first flow path 21 and the third flow path 23 form a closed circuit via the valve mechanism 40 in the drive device temperature control circuit 20. Further, the port 44 and the port 45 are in communication with each other via the internal passage of the valve mechanism 40, and thus the fourth flow path 34 forms a closed circuit via the valve mechanism 40 in the battery temperature control circuit 30. That is, in the second mode, the drive device temperature control circuit 20 and the battery temperature control circuit 30 are independent of each other.

In the second mode, the refrigerant circulating through the drive device temperature control circuit 20 receives heat from the heat generating device H and radiates heat to an outside of the vehicle at the radiator 28. Thus, the heat generating device H is cooled. Meanwhile, the refrigerant circulating through the battery temperature control circuit 30 warms the battery 5 by operating the liquid heater 38 or cools the battery 5 via the chiller 36.

As shown in FIG. 6, the third mode is a mode in which the drive device temperature control circuit 20 and the battery temperature control circuit 30 are in communication with each other (that is, the communication state), and the refrigerant does not flow through the radiator 28 in the drive device temperature control circuit 20. The port 42 and the port 45 are in communication with each other via the internal passage of the valve mechanism 40, and the port 43 and the port 44 are in communication with each other via the internal passage of the valve mechanism 40. Thus, the first flow path 21, the second flow path 22, and the fourth flow path 34 form a closed circuit via the valve mechanism 40. That is, the drive device temperature control circuit 20 and the battery temperature control circuit 30 form an integrated circuit, and the refrigerant circulates between the drive device temperature control circuit 20 and the battery temperature control circuit 30.

In the third mode, the refrigerant flowing through the drive device temperature control circuit 20 stores the heat received from the heat generating device H without radiating the heat at the radiator 28. Then, the refrigerant flows into the battery temperature control circuit 30, and the heat stored in the refrigerant is discharged to the battery 5. In this way, since the heat generating device H is cooled, and the heat generated by the heat generating device H can be used to warm the battery 5, power consumption of the liquid heater 38 can be reduced when warming the battery 5. In the third mode, since the refrigerant does not pass through the radiator 28, it is not necessary to operate the electric fan 28f, and power consumption of the electric fan 28f can be reduced.

As shown in FIG. 7, the fourth mode is a mode in which the drive device temperature control circuit 20 and the battery temperature control circuit 30 are in communication with each other (that is, the communication state), and the refrigerant flows through the radiator 28 in the drive device temperature control circuit 20. The port 41 and the port 45 are in communication with each other via the internal passage of the valve mechanism 40, and the port 43 and the port 44 are in communication with each other via the internal passage of the valve mechanism 40. Thus, the first flow path 21, the third flow path 23, and the fourth flow path 34 form a closed circuit via the valve mechanism 40. As the third mode, the drive device temperature control circuit 20 and the battery temperature control circuit 30 form an integrated circuit, and the refrigerant circulates between the drive device temperature control circuit 20 and the battery temperature control circuit 30.

In the fourth mode, the refrigerant circulating through the drive device temperature control circuit 20 receives heat from the heat generating device H and radiates the heat to the outside of the vehicle at the radiator 28. The refrigerant cooled by the radiator 28 flows to the battery temperature control circuit 30 to cool the battery 5. In other words, the battery 5 is cooled via the radiator 28. At this time, since the battery 5 can be cooled without operating the chiller 36, power consumption of the electric compressor in the refrigeration cycle can be reduced.

Since the temperature control system 10 has the first mode to the fourth mode, the temperatures of the battery 5 and the heat generating device H can be finely managed in consideration of a temperature control performance (a cooling performance and a warming performance), a cruising distance of the vehicle 1, and the like. The control device 50 of the present embodiment selects any one of the first mode to the fourth mode based on the state of the vehicle 1.

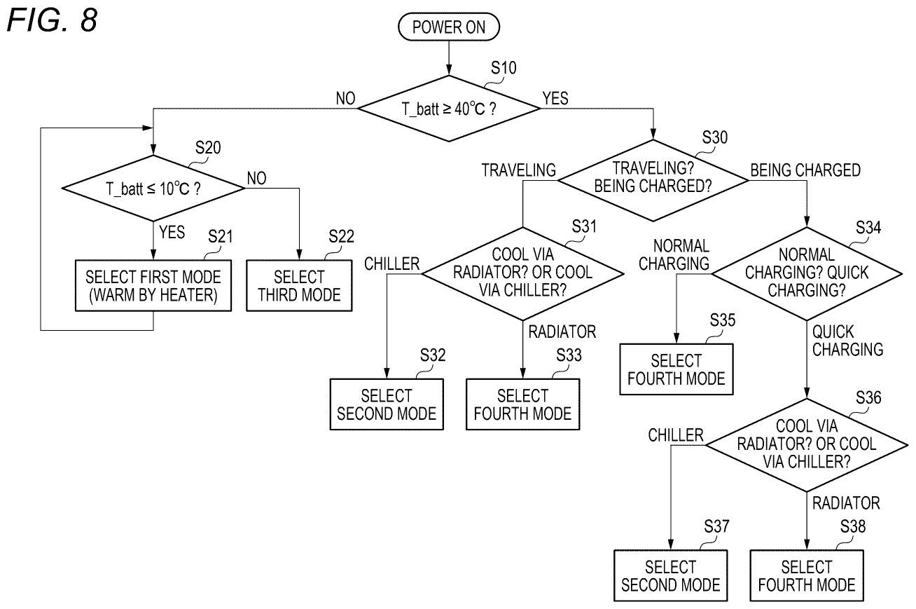

Hereinafter, an example of a mode selection process performed by the control device 50 will be described with reference to a flowchart of FIG. 8. This flowchart is repeatedly executed at predetermined time intervals while a power supply of the vehicle 1 is ON (ignition is ON). Specific values of the temperature and the SOC to be exemplified below are examples when the battery 5 is an all-solid-state battery, for example.

First, the control device 50 determines whether the battery temperature (T_batt in the flowchart) is equal to or higher than a first threshold value (step S10). The first threshold value is a temperature higher than a general outside air temperature, and will be described below as 40° C., for example.

When the battery temperature is lower than the first threshold value (40° C.) (step S10: NO), the control device 50 determines whether the battery temperature is equal to or lower than a second threshold value (step S20). The second threshold value is a temperature at which active warming of the battery 5 is required in order to prevent a decrease in input and output of the battery 5, and will be described below as 10° C., for example.

When the battery temperature is equal to or lower than the second threshold value (10° C.) (step S20: YES), the control device 50 selects the first mode (step S21). In a state where the temperature control system 10 is set to the first mode, the control device 50 operates the liquid heater 38 to warm the battery 5. Meanwhile, in the drive device temperature control circuit 20, the refrigerant stores heat from the heat generating device H while circulating through the first flow path 21 and the second flow path 22. After selecting the first mode, the control device 50 monitors the battery temperature in step S20 until the battery temperature is higher than 10° C.

When the battery temperature is higher than the second threshold value (10° C.) (step S20: NO), the control device 50 selects the third mode (step S22). In the third mode, since the heat of the heat generating device H is discharged to the battery 5, the battery 5 can be warmed using the heat of the heat generating device H. Accordingly, an energy loss in the temperature control system 10 can be reduced. Since the battery 5 can be warmed without operating the liquid heater 38, power consumption of the battery 5 can be reduced while maintaining a temperature control performance of the battery 5, and the cruising distance of the vehicle 1 can be increased.

When the battery temperature is equal to or higher than the first threshold value (40° C.) (step S10: YES), the control device 50 determines whether the vehicle 1 is traveling or being charged (step S30). The control device 50 of the present embodiment determines a mode to be selected based on whether the vehicle 1 is traveling or being charged as the state of the vehicle 1. Here, the “traveling” refers to a state in which the vehicle 1 is not connected to the charging equipment 100, and includes not only a state in which the vehicle 1 is actually traveling, but also a state in which the vehicle 1 is stopped and not connected to the charging equipment 100.

When the vehicle 1 is traveling, the control device 50 determines whether to cool the battery 5 via the radiator 28 or via the chiller 36 (step S31). Specifically, the control device 50 determines whether to perform the cooling via the radiator 28 or via the chiller 36 based information of the outside air temperature and the SOC of the battery 5.

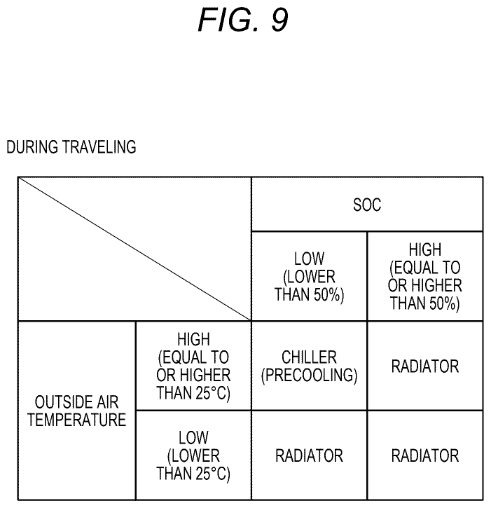

As shown in FIG. 9, when the outside air temperature is lower than a predetermined threshold value (for example, 25° C.), a temperature difference between the battery temperature and the outside air temperature is large, so that the control device 50 selects to perform cooling via the radiator 28. Even when the outside air temperature is equal to or higher than the predetermined threshold value, if the SOC of the battery 5 is equal to or higher than a predetermined threshold value (for example, 50%), the control device 50 selects to perform cooling via the radiator 28. In this way, when the vehicle 1 is traveling, since the battery 5 is basically cooled via the radiator 28, the power consumption of the battery 5 for operating the chiller 36 (that is, operating the electric compressor in the refrigeration cycle) can be reduced. Accordingly, a decrease in the cruising distance of the vehicle 1 can be prevented.

On the other hand, when the outside air temperature is equal to or higher than the predetermined threshold value and the SOC of the battery 5 is lower than the predetermined threshold value, the control device 50 selects to perform cooling via the chiller 36. This is because the vehicle 1 is charged quickly after traveling since the SOC of the battery 5 is lower than a predetermined threshold value. Since an amount of heat generated by the battery 5 is large during quick charging, it is preferable to previously cool the battery 5 before the quick charging. When the outside air temperature is high and the temperature difference between the battery temperature and the outside air temperature is small, the battery 5 can be cooled with a sufficient cooling performance before the quick charging using the chiller 36 instead of the radiator 28.

Returning to FIG. 8, when determining to cool the battery 5 via the chiller 36 while the vehicle 1 is traveling, the control device 50 selects the second mode (step S32). Then, the control device 50 operates the chiller 36 (the electric compressor) to cool the battery 5.

When determining to cool the battery 5 via the radiator 28 while the vehicle 1 is traveling, the control device 50 selects the fourth mode (step S33). Then, the control device 50 operates the electric fan 28f to cool the battery 5 via the radiator 28.

In step S30, when the vehicle 1 is being charged, the control device 50 determines whether vehicle 1 is being normally charged or being quickly charged (step S34).

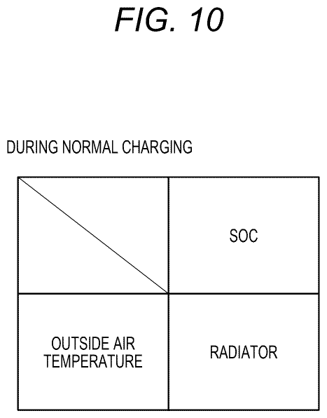

When the vehicle 1 is being normally charged, the control device 50 selects the fourth mode (step S35). As shown in FIG. 10, when the vehicle 1 is being normally charged, the battery 5 is cooled via the radiator 28 regardless of the outside air temperature and the SOC of the battery 5. Since a cooling load of the battery 5 is relatively small during normal charging, the battery 5 is cooled via the radiator 28 without operating the chiller 36 (the electric compressor).

When the vehicle 1 is being quickly charged, the control device 50 determines whether to cool the battery 5 via the radiator 28 or via the chiller 36 (step S36). Specifically, the control device 50 determines whether to perform the cooling via the radiator 28 or via the chiller 36 based information of the outside air temperature and the SOC of the battery 5.

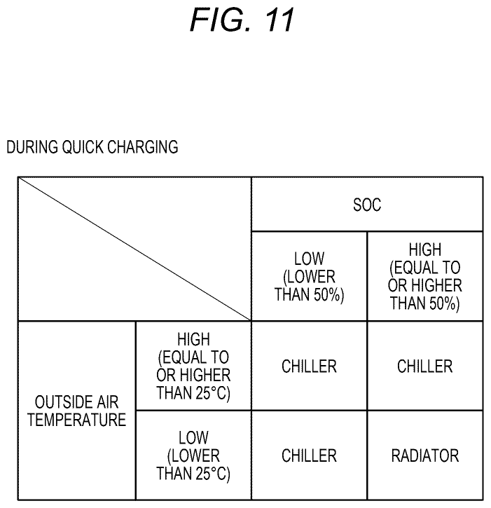

As shown in FIG. 11, when the outside air temperature is equal to or higher than a predetermined threshold value (for example, 25° C.), the control device 50 selects to perform cooling via the chiller 36. This is to ensure a sufficient cooling performance since the amount of heat generated by the battery 5 is large during the quick charging. Even when the outside air temperature is lower than the predetermined threshold value, if the SOC of the battery 5 is lower than a predetermined threshold value (for example, 50%), the control device 50 selects to perform cooling via the chiller 36. In this way, when the vehicle 1 is being quickly charged, since the battery 5 is basically cooled via the chiller 36, the battery 5 can be cooled with a sufficient cooling performance.

On the other hand, when the outside air temperature is lower than the predetermined threshold value and the SOC of the battery 5 is equal to or higher than the predetermined threshold value, the control device 50 selects to perform cooling via the radiator 28. This is because when the temperature difference between the battery temperature and the outside air temperature is large and the SOC of the battery 5 is high and the amount of heat generated by the battery 5 is relatively small, it is sufficient to perform cooling via the radiator 28.

Returning to FIG. 8, when determining to cool the battery 5 via the chiller 36 during the quick charging, the control device 50 selects the second mode (step S37). Then, the control device 50 operates the chiller 36 (the electric compressor) to cool the battery 5.

When determining to cool the battery 5 via the radiator 28 during the quick charging, the control device 50 selects the fourth mode (step S38). Even during the quick charging, a mode in which cooling can be performed via the radiator 28 can be selected when cooling by the radiator 28 is sufficient, and thus power consumption of the battery 5 required for operating the chiller 36 can be reduced. Accordingly, the decrease in the cruising distance of the vehicle 1 can be prevented.

As described above, the control device 50 selects any one of the first mode to the fourth mode based on the state of the vehicle. Thus, the control device 50 can select an optimum mode capable of preventing the decrease in the temperature control performance of the battery 5 and in the cruising distance of the vehicle 1.

The control device 50 closes the active grille shutter 29 when selecting the first mode or the third mode in which the refrigerant flows while bypassing the radiator 28, and opens the active grille shutter 29 when selecting the second mode or the fourth mode in which the refrigerant flows through the radiator 28. Since the active grille shutter 29 is closed when the first mode or the third mode is selected, travelling resistance of the vehicle 1 and the power consumption of the electric fan 28f can be reduced. Since the active grille shutter 29 is opened when the second mode or the fourth mode is selected, temperature control efficiency of the drive device temperature control circuit 20 can be improved.

As shown in FIGS. 8 to 11, the control device 50 selects any one of the modes based on the outside air temperature and the SOC of the battery 5, and thus can prevent the decrease in the temperature control performance of the battery 5 and in the cruising distance of the vehicle 1 by selecting an appropriate mode. In the example of the mode selection process shown in FIG. 8, a configuration is shown in which the control device 50 selects the second mode or the fourth mode based on the outside air temperature and the SOC of the battery 5, but the present disclosure is not limited thereto, and the configuration may be such that any one of the first mode to the fourth mode, including the first mode and the third mode, is selected.

Further, the control device 50 selects any one of the modes based on the information indicating whether the vehicle 1 is being charged or traveling, and thus can prevent the decrease in the temperature control performance of the battery 5 and in the cruising distance of the vehicle 1 by selecting an appropriate mode. In the example of the mode selection process shown in FIG. 8, a configuration is shown in which the control device 50 selects the second mode or the fourth mode based on the information indicating whether the vehicle 1 is being charged or traveling, but the present disclosure is not limited thereto, and the configuration may be such that any one of the first mode to the fourth mode, including the first mode and the third mode, is selected.

Further, the control device 50 selects any one of the modes based on the information indicating whether the vehicle 1 is being normally charged or being quickly charged when the vehicle 1 is being charged, and thus can prevent the decrease in the temperature control performance of the battery 5 and in the cruising distance of the vehicle 1 by selecting an appropriate mode. In the example of the mode selection process shown in FIG. 8, a configuration is shown in which the control device 50 selects the second mode or the fourth mode based on the information indicating whether the vehicle 1 is being normally charged or being quickly charged, but the present disclosure is not limited thereto, and the configuration may be such that any one of the first mode to the fourth mode, including the first mode and the third mode, is selected.

Further, the control device 50 selects any one of the modes based on the information indicating whether the vehicle 1 is being normally charged or being quickly charged and the SOC of the battery 5, and thus can prevent the decrease in the temperature control performance of the battery 5 and in the cruising distance of the vehicle 1 by selecting an appropriate mode.

Specifically, when the vehicle 1 is being quickly charged and the outside air temperature is equal to or higher than a predetermined temperature (for example, 25° C.), or when the vehicle 1 is being quickly charged, the outside air temperature is lower than the predetermined temperature and the SOC of the battery 5 is lower than a predetermined value (for example, 50%), the control device 50 selects the second mode and cools the battery 5 via the chiller 36. In this way, when the cooling performance cannot be sufficiently secured in the cooling of the battery 5 by the radiator 28, the second mode is selected to cool the battery 5 via the chiller 36, and thus the decrease in the cooling performance of the battery 5 can be prevented. When the vehicle 1 is being normally charged, or when the vehicle 1 is being quickly charged, the outside air temperature is lower than the predetermined temperature, and the SOC of the battery 5 is equal to or higher than the predetermined value, the control device 50 selects the fourth mode to cool the battery 5 via the radiator 28. In this way, when the cooling performance can be secured in the cooling of the battery 5 by the radiator 28, the fourth mode is selected to cool the battery 5 via the radiator 28, and thus the power consumption of the battery 5 required for operating the chiller 36 (operating the electric compressor in the refrigeration cycle) can be reduced, and the decrease in the cruising distance of the vehicle 1 can be prevented.

Further, the control device 50 selects any one of the modes based on the temperature of the battery 5, and thus the decrease in the temperature control performance of the battery 5 can be prevented by selecting an appropriate mode.

Specifically, as in the example of the mode selection process shown in FIG. 8, the control device 50 selects the first mode or the third mode when the battery temperature is lower than the first threshold value (for example, 40° C.), and selects the second mode or the fourth mode when the battery temperature is equal to or higher than the first threshold value.

Although one embodiment of the present disclosure has been described above with reference to the accompanying drawings, it is needless to say that the present disclosure is not limited to the embodiment. It is apparent that those skilled in the art can conceive of various modifications and alterations within the scope described in the claims, and it is understood that such modifications and alterations naturally fall within the technical scope of the present disclosure. In addition, the components in the above embodiment may be freely combined without departing from the gist of the disclosure.

For example, in the embodiment described above, a case in which the battery 5 is an all-solid-state battery has been described as an example, but the present disclosure is not limited thereto, and the battery 5 may be a liquid battery or a semi-solid battery.

In this specification, at least the following matters are described. In the parentheses, corresponding components and the like in the above embodiment are illustrated as an example, but the present disclosure is not limited thereto.
(1) A temperature control system (a temperature control system 10) to be mounted on a vehicle (a vehicle 1), the temperature control system including:
a first refrigerant circuit (a drive device temperature control circuit 20) provided with a first heat exchanger (a radiator 28) and configured to allow a refrigerant to flow therethrough to adjust a temperature of a heat generating device (a heat generating device H (a drive device 2, a charger 6, and a DC/DC converter 4)) of the vehicle;
a second refrigerant circuit (a battery temperature control circuit 30) provided with a second heat exchanger (a chiller 36) and configured to allow the refrigerant to flow therethrough to adjust a temperature of a power storage device (a battery 5) of the vehicle;
a valve mechanism (a valve mechanism 40) provided between the first refrigerant circuit and the second refrigerant circuit; and
a control device (a control device 50) configured to control the valve mechanism, wherein
the first refrigerant circuit includes a flow path (a second flow path 22) configured to allow the refrigerant to flow therethrough while bypassing the first heat exchanger, and a flow path (a third flow path 23) configured to allow the refrigerant to flow through the first heat exchanger, and
the control device selects, based on a state of the vehicle, any one of
a first mode in which the first refrigerant circuit and the second refrigerant circuit are not in communication with each other, and the refrigerant does not flow through the first heat exchanger in the first refrigerant circuit,
a second mode in which the first refrigerant circuit and the second refrigerant circuit are not in communication with each other, and the refrigerant flows through the first heat exchanger in the first refrigerant circuit,
a third mode in which the first refrigerant circuit and the second refrigerant circuit are in communication with each other via the valve mechanism, and the refrigerant does not flow through the first heat exchanger in the first refrigerant circuit, and
a fourth mode in which the first refrigerant circuit and the second refrigerant circuit are in communication with each other via the valve mechanism, and the refrigerant flows through the first heat exchanger in the first refrigerant circuit.

According to (1), since the first refrigerant circuit and the second refrigerant circuit have a plurality of modes regarding a flow of the refrigerant, the flow of the refrigerant in the refrigerant circuit can be finely set. Thus, by selecting an appropriate mode from the plurality of modes based on the state of the vehicle, a decrease in a temperature control performance of the power storage device and in a cruising distance of the vehicle can be prevented.
(2) The temperature control system according to (1), in which
the first heat exchanger is a radiator provided behind a front grille of the vehicle,
the front grille is provided with a grille shutter (an active grille shutter 29) that is able to be opened and closed in response to an instruction from the control device, and
the control device closes the grille shutter when the first mode or the third mode is selected, and opens the grille shutter when the second mode or the fourth mode is selected.

According to (2), since the grille shutter is closed when the refrigerant does not flow through the radiator (the first heat exchanger), traveling resistance of the vehicle and power consumption of an electric fan of the radiator can be reduced. Meanwhile, since the grille shutter is opened when the refrigerant flows through the radiator, a temperature control performance of the refrigerant circuit can be improved.
(3) The temperature control system according to (1), in which
the control device selects any one of the modes based on information on an outside air temperature and a state of charge of the power storage device.

According to (3), by selecting an appropriate mode from the plurality of modes based on the outside air temperature and the state of charge of the power storage device, the decrease in the temperature control performance of the power storage device and in the cruising distance of the vehicle can be prevented.
(4) The temperature control system according to (1), in which
the control device selects any one of the modes based on information on whether the vehicle is being charged or traveling.

According to (4), by selecting an appropriate mode from the plurality of modes based on the information on whether the vehicle is being charged or traveling, the decrease in the temperature control performance of the power storage device and in the cruising distance of the vehicle can be prevented.
(5) The temperature control system according to (4), in which
when the vehicle is being charged, the control device selects any one of the modes based on information on whether the vehicle is being normally charged or being quickly charged.

According to (5), by selecting an appropriate mode from the plurality of modes based on the information on whether the vehicle is being normally charged or being quickly charged, the decrease in the temperature control performance of the power storage device and in the cruising distance of the vehicle can be prevented.
(6) The temperature control system according to (1), in which
the control device selects any one of the modes based on information on whether the vehicle is being normally charged or being quickly charged and information on an outside air temperature and a state of charge of the power storage device.

According to (6), by selecting an appropriate mode from the plurality of modes based on the information on whether the vehicle is being normally charged or being quickly charged, and the information on the outside air temperature and the state of charge of the power storage device, the decrease in the temperature control performance of the power storage device and in the cruising distance of the vehicle can be prevented.
(7) The temperature control system according to (6), in which
the control device
selects the second mode when the vehicle is being quickly charged and the outside air temperature is equal to or higher than a predetermined temperature, or when the vehicle is being quickly charged, the outside air temperature is lower than the predetermined temperature and the state of charge of the power storage device is lower than a predetermined value, and
selects the fourth mode when the vehicle is being normally charged, or when the vehicle is being quickly charged, the outside air temperature is lower than the predetermined temperature and the state of charge of the power storage device is equal to or higher than the predetermined value.

According to (7), in a case where the cooling of the power storage device by the first heat exchanger may be insufficient, since the second mode can be selected to cool the power storage device by the second heat exchanger, the decrease in the temperature control performance of the power storage device can be prevented. Further, when the cooling of the power storage device by the first heat exchanger is sufficient, since the fourth mode can be selected to cool the power storage device by the first heat exchanger, power consumption required for operating the second heat exchanger can be reduced, and the decrease in the cruising distance can be prevented.
(8) The temperature control system according to (1), in which
the control device selects any one of the modes based on the temperature of the power storage device.

According to (8), by selecting an appropriate mode based on the temperature of the power storage device, the decrease in the temperature control performance of the power storage device can be prevented.
(9) The temperature control system according to (8), in which
the control device
selects the first mode or the third mode when the temperature of the power storage device is lower than a predetermined threshold value, and
selects the second mode or the fourth mode when the temperature of the power storage device is equal to or higher than the predetermined threshold value.

According to (9), when the temperature of the power storage device is low, the first mode or the third mode is selected to prevent the refrigerant from radiating heat at the first heat exchanger, and when the temperature of the power storage device is high, the second mode or the fourth mode is selected to allow the refrigerant to radiate heat at the first heat exchanger, and thus a temperature control performance of the temperature control system can be improved.
(10) The temperature control system according to any one of (1) to (9), in which
the power storage device is an all-solid-state battery.

Since the all-solid-state battery is resistant to a higher temperature than a liquid battery, according to (10), a usable temperature range of the power storage device can be expanded.

1. A temperature control system to be mounted on a vehicle, the temperature control system comprising:
a first refrigerant circuit provided with a first heat exchanger and configured to allow a refrigerant to flow therethrough to adjust a temperature of a heat generating device of the vehicle;
a second refrigerant circuit provided with a second heat exchanger and configured to allow the refrigerant to flow therethrough to adjust a temperature of a power storage device of the vehicle;
a valve mechanism provided between the first refrigerant circuit and the second refrigerant circuit; and
a control device configured to control the valve mechanism, wherein
the first refrigerant circuit includes a flow path configured to allow the refrigerant to flow therethrough while bypassing the first heat exchanger, and a flow path configured to allow the refrigerant to flow through the first heat exchanger, and
the control device selects, based on a state of the vehicle, any one of
a first mode in which the first refrigerant circuit and the second refrigerant circuit are not in communication with each other, and the refrigerant does not flow through the first heat exchanger in the first refrigerant circuit,
a second mode in which the first refrigerant circuit and the second refrigerant circuit are not in communication with each other, and the refrigerant flows through the first heat exchanger in the first refrigerant circuit,
a third mode in which the first refrigerant circuit and the second refrigerant circuit are in communication with each other via the valve mechanism, and the refrigerant does not flow through the first heat exchanger in the first refrigerant circuit, and
a fourth mode in which the first refrigerant circuit and the second refrigerant circuit are in communication with each other via the valve mechanism, and the refrigerant flows through the first heat exchanger in the first refrigerant circuit.

2. The temperature control system according to claim 1, wherein
the first heat exchanger is a radiator provided behind a front grille of the vehicle,
the front grille is provided with a grille shutter that is able to be opened and closed in response to an instruction from the control device, and
the control device closes the grille shutter when the first mode or the third mode is selected, and opens the grille shutter when the second mode or the fourth mode is selected.

3. The temperature control system according to claim 1, wherein
the control device selects any one of the modes based on information on an outside air temperature and a state of charge of the power storage device.

4. The temperature control system according to claim 1, wherein
the control device selects any one of the modes based on information on whether the vehicle is being charged or traveling.

5. The temperature control system according to claim 4, wherein
when the vehicle is being charged, the control device selects any one of the modes based on information on whether the vehicle is being normally charged or being quickly charged.

6. The temperature control system according to claim 1, wherein
the control device selects any one of the modes based on information on whether the vehicle is being normally charged or being quickly charged and information on an outside air temperature and a state of charge of the power storage device.

7. The temperature control system according to claim 6, wherein
the control device selects the second mode (i) when the vehicle is being quickly charged and the outside air temperature is equal to or higher than a predetermined temperature, or (ii) when the vehicle is being quickly charged, the outside air temperature is lower than the predetermined temperature and the state of charge of the power storage device is lower than a predetermined value, and
the control device selects the fourth mode (iii) when the vehicle is being normally charged, or (iv) when the vehicle is being quickly charged, the outside air temperature is lower than the predetermined temperature and the state of charge of the power storage device is equal to or higher than the predetermined value.

8. The temperature control system according to claim 1, wherein
the control device is configured to select any one of the modes based on the temperature of the power storage device.

9. The temperature control system according to claim 8, wherein
the control device selects the first mode or the third mode when the temperature of the power storage device is lower than a predetermined threshold value, and
the control device selects the second mode or the fourth mode when the temperature of the power storage device is equal to or higher than the predetermined threshold value.

10. The temperature control system according to claim 1, wherein
the power storage device is an all-solid-state battery.
